(19) United States
(12) Patent Application Publication
(10) Pub. No.: US 2010/0239384 A1
(43) Pub. Date: Sep. 23, 2010

(54) MOLLY BOLT

(76) Inventor: Chien-Ming LU, Taichung City (TW)

Correspondence Address: Muncy, Geissler, Olds & Lowe, PLLC, 4000 Legato Road, Suite 310, FAIRFAX, VA, 22033, US

(21) Appl. No.: 12/408,955

(22) Filed: Mar. 23, 2009

(51) Int. Cl. F16B 13/04

(52) U.S. Cl. 411/30

(57) ABSTRACT

A molly bolt has a fastener, a sleeve and a tip. The fastener has a head and a shaft. The shaft is formed on and protrudes from the head and has a threaded segment. The sleeve is mounted around the shaft and has a fixing end, a rim, a compressing segment and an asymmetric structure. The fixing end is disposed adjacent to the head. The rim is formed around the fixing end. The compressing segment is formed from and protrudes from the fixing end. The asymmetric structure is a slot or multiple asymmetric slots respectively formed in the compressing segment. The tip is mounted on the connecting end of the fastener. The asymmetric structure causes asymmetric deformation preventing the molly bolt from loosening.

### BACKGROUND OF THE INVENTION

1. Field of the Invention

The present invention relates to a fastener, and more particularly to a molly bolt with a sleeve having an asymmetric structure and being asymmetrically compressed for improved fastening.

2. Description of Related Art

With reference to FIGS. 9 and 10, a conventional molly bolt comprises a fastener (50), a tip (70) and a sleeve (60).

The fastener (50) has a head (51), a shaft (52) and a connecting end (53). The head (51) has a tool mount corresponding to a tool, such as, a straight recess for a flat-head screwdriver, a hexagonal recess for a hex-key, or hexagonal protrusion for a wrench, socket or the like. The shaft (52) is narrower than and protrudes from the head (51) and has a threaded segment (520) and a distal end. The threaded segment (520) is formed around the shaft (52).

The tip (70) is mounted on the connecting end (53) of the fastener (50) and has at least one tapering blade (71).

The sleeve (60) is movably mounted around the shaft (52) and has a fixing end (61), a rim (64), a compressing segment (63), an engaging end and multiple slots (62). The fixing end (61) is disposed adjacent to the head (51) of the fastener (50). The rim (64) is formed around and protrudes from the fixing end (61). The compressing segment (63) is formed on and protrudes from the fixing end (61). The engaging end is formed on and protrudes from the compressing segment (63) and engages the distal end of the shaft (52). The multiple slots (62) are parallelly formed longitudinally in the compressing segment (63).

In use, the tool engages the tool mount of the head (51) and drives the molly bolt into a wall, such as, a board, plaster wall or the like. The tapering blade (71) of the tip (70) is driven to drill a hole through the wall and the molly bolt follows into the hole of the board until the fixing end (61) of the sleeve (60) abuts the wall. When the rim (64) of the sleeve (60) abuts one side of the board, continued rotation of the fastener (50) causes the engaging end of the sleeve (60) to be pulled toward the fixing end (61) and the compressing segment (63) deforms. Because the slots (62) are symmetrical, the compressing segment (63) deforms in an annular symmetrical deformation (69), which abuts an inner side of the wall and holds the molly bolt securely in the hole of the board. However, because the sleeve (60) is resilient, the compressing segment (63) has a returning force (F) against the deformation (69) and toward the tip (70). The returning force (F) causes the fastened deformation (69) to move toward the tip (70) and the molly bolt becomes unfastened.

Further, when the deformation (69) is tightly fastened, but continued driving the fastener (50), the hole of the board will be reamed.

To overcome the shortcomings, the present invention tends to provide a molly bolt to mitigate or obviate the aforementioned problems.

### SUMMARY OF THE INVENTION

The main objective of the invention is to provide a molly bolt with a sleeve having an asymmetric structure and being asymmetrically compressed for improved fastening.

The molly bolt has a fastener, a sleeve and a tip. The fastener has a head and a shaft. The shaft is formed on and protrudes from the head and has a threaded segment. The sleeve is mounted around the shaft and has a fixing end, a rim, a compressing segment and an asymmetric structure. The fixing end is disposed adjacent to the head. The rim is formed around the fixing end. The compressing segment is formed from and protrudes from the fixing end. The asymmetric structure is a slot or multiple asymmetric slots respectively formed in the compressing segment. The tip is mounted on the connecting end of the fastener. The asymmetric structure causes asymmetric deformation preventing the molly bolt from loosening.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a molly bolt in accordance with the present invention;

FIG. 2 is an exploded perspective view of the molly bolt in FIG. 1;

FIG. 3 is a side view of the molly bolt in FIG. 1;

FIG. 4 is an enlarged cross sectional end view of a sleeve of a second embodiment of a molly bolt in accordance with the present invention;

FIG. 5 is a side view of a third embodiment of a molly bolt in accordance with the present invention;

FIG. 6 is a series of operational side views in partial section of the molly bolt in FIG. 1;

FIG. 7 is an enlarged side view in partial section showing the deformation of the molly bolt in FIG. 6;

FIG. 8 is a perspective view of a fourth embodiment of the molly bolt in accordance with the present invention;

FIG. 9 is a perspective view of a conventional molly bolt in accordance with the prior art; and

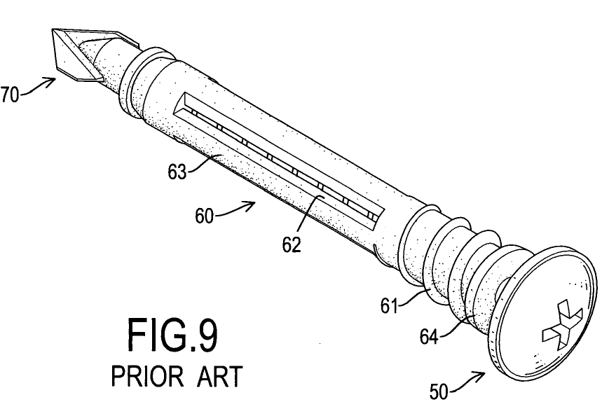

FIG. 10 is an operational side view in partial section of the molly bolt in FIG. 9.

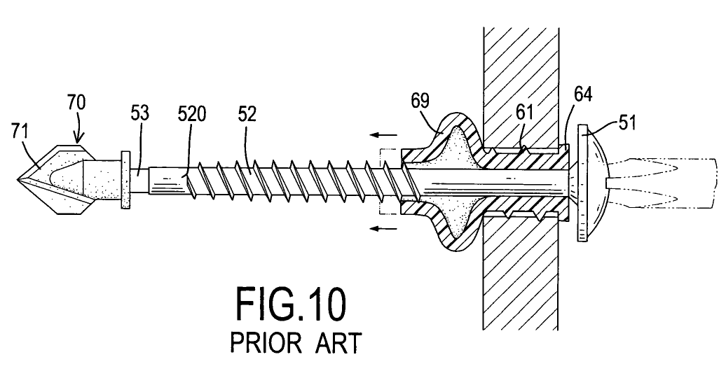

### DETAILED DESCRIPTION OF PREFERRED EMBODIMENT

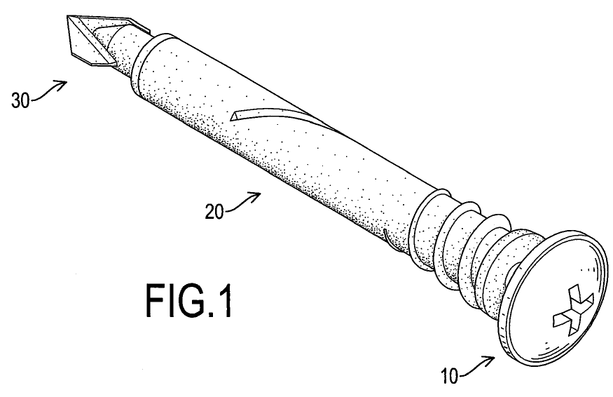

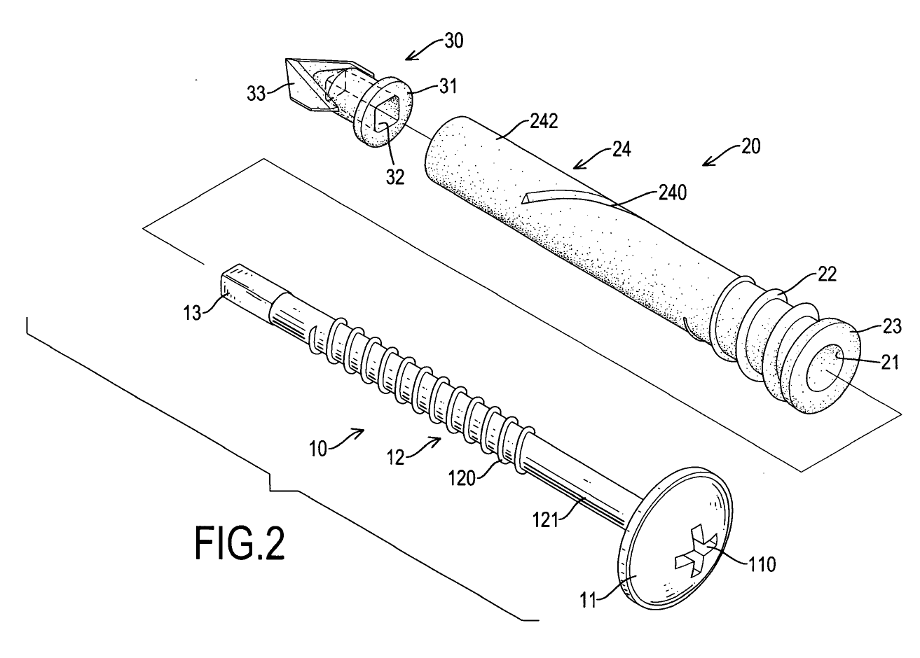

With reference to FIGS. 1, 2 and 8, a molly bolt in accordance with the present invention comprises a fastener (10), a sleeve (20), a tip (30) and an optional bracket (40).

The fastener (10) has a head (11), a shaft (12) and a connecting end (13). The head (11) has an outer surface and a tool mount (110). The tool mount (110) is formed in the outer surface of the head (11), corresponds to a tool and may be, but is not limited to a straight recess corresponding to a flat-head screwdriver, a cross recess corresponding to a cross-head screwdriver, a polygonal recess corresponding to a hex-key, a polygonal protrusion corresponding to a wrench, socket or the like.

The shaft (12) is formed on and protrudes from the head (10), may be narrower than the head (10) and has a smooth segment (121), a threaded segment (120) and an engaging segment. The smooth segment of the shaft (12) is connected to the head (10) and is substantially cylindrical. The threaded segment (120) is formed adjacent to the smooth segment (121). The engaging segment is connected to the threaded segment (120).

The connecting end (13) is formed from the engaging segment of the shaft (12), is non-circular in cross section, and may be wedging or polygonal.

The sleeve (20) is movably mounted around the shaft (12) of the fastener (10), is deformable, and may be pliant and resilient material such as plastic or the like, and has a through hole (21), a fixing end (22), a rim (23), a compressing segment (24) and an engaging end.

The through hole (21) is formed through the sleeve (20), is mounted around the shaft (12) of the fastener (10) and may be a tapering hole.

The fixing end (22) is disposed adjacent to the head (11) of the fastener (10) and has an external thread.

The rim (23) is formed on the sleeve (20) at the fixing end (22) of the sleeve (20).

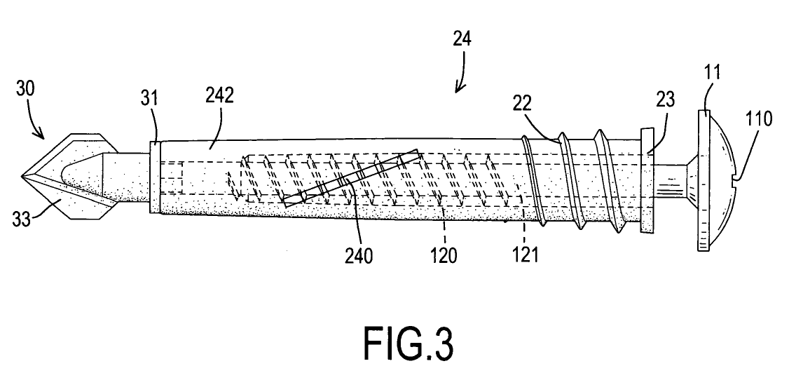

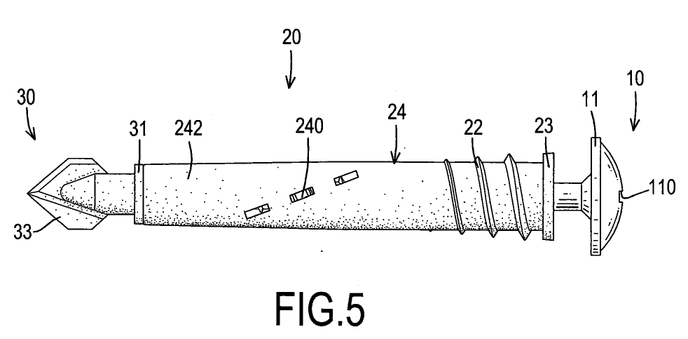

With further reference to FIGS. 3 and 5, the compressing segment (24) is connected to the fixing end (22), and is mounted around the shaft (12) and has an asymmetric structure (240) and an engaging end (242). The asymmetric structure (240) is formed asymmetrically in the compressing segment (24) and may be a slot, multiple slots, at least one straight slot, at least one slanted slot, at least one curved slot or multiple aligning slots.

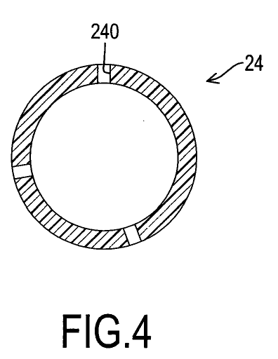

With further reference to FIG. 4, the asymmetric structure (240) may be multiple asymmetric slots and multiple cambers. The multiple asymmetric slots are asymmetrically formed in the compressing segment (24) and may be straight slots or slanted slots. The cambers between adjacent slots are formed on the compressing segment (24) and have lengths. The length of at least one of the cambers is different from that of the other cambers.

Furthermore, the multiple asymmetric structure (240) may be multiple curved slots, respectively formed around the compressing segment (24), and formed side-by-side in the sleeve (20). The curved slots are arcs less than 180°.

With further reference to FIG. 5, the at least one slot of the asymmetric structure (240) may be formed intermittently in the compressing segment (24) by multiple aligning crevices.

The engaging end (242) of the sleeve (20) is formed adjacent to the compressing segment (24) and may engage the engaging segment of the shaft (12).

The tip (30) is detachably mounted on the connecting end (13) of the fastener (10), and has a mounting hole (32), a shoulder (31) and a blade (33). The mounting hole (32) is formed in the tip (30), and is mounted on the connecting end (13) of the shaft (13), and may be wedging or polygonal. The shoulder (31) is annular and protrudes from the tip (30), and may abut the engaging end (242) of the sleeve (20). The blade (33) is formed on the tip (30) and is tapered.

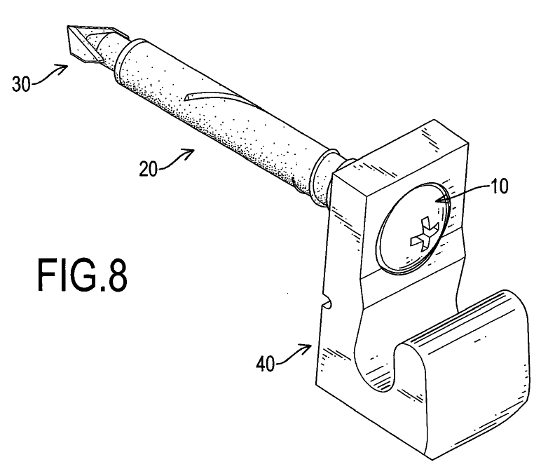

With further reference to FIG. 8, the bracket (40) is mounted on the smooth segment (121) of the fastener (10) and may be a hook, mounting plate, loop or the like.

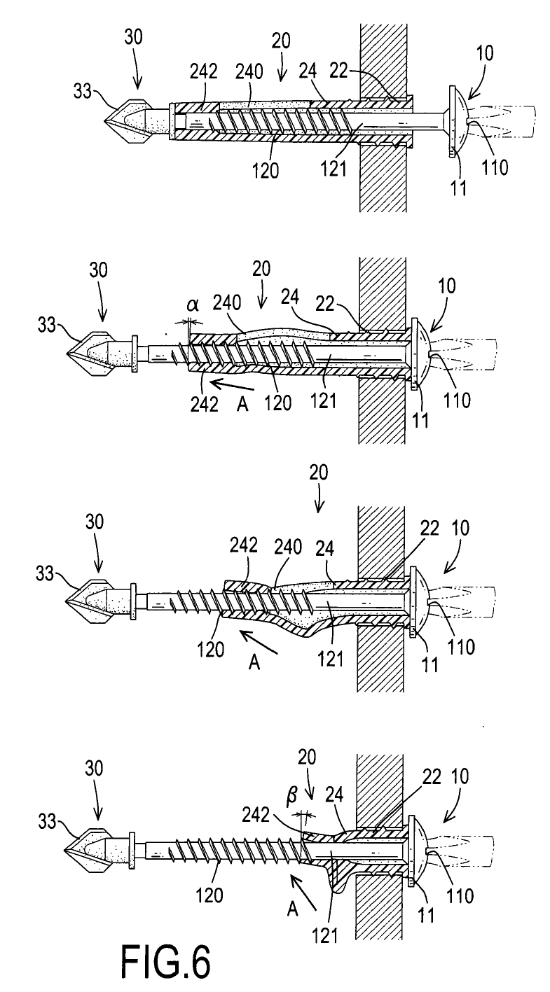

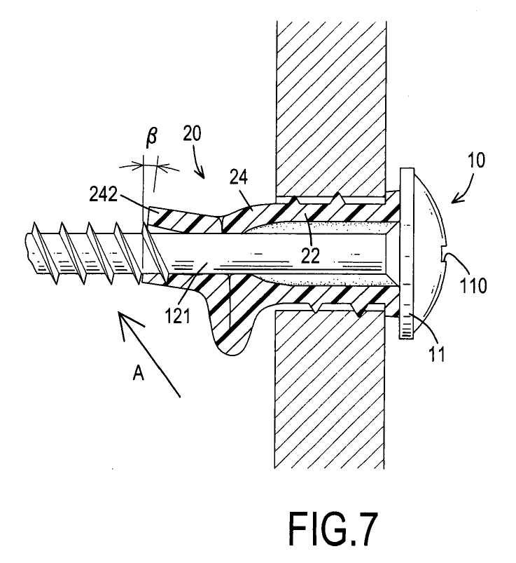

With further reference to FIGS. 6 and 7, in use, a screwdriver engages the tool mount (110) of the fastener (10) to drive the molly bolt into a wall such as a board, a plaster wall or the like. The blade (33) of the tip (30) drills a hole through the board, after which the sleeve (20) and the fastener (10) follow and are mounted in the wall. When the rim (23) of the sleeve (20) abuts the wall around the hole of the wall, by continually rotating the fastener (10), the engaging end of the sleeve (20) engages the engaging segment of the fastener (10) and is pulled toward the smooth segment (121) along the thread of the thread segment (120).

Due to the asymmetric structure (240), the engaging end of the compressing segment (240) becomes slanted, and further tightening causes an angle of slant to increase (from α to β) and is fastened tightly in the wall. Therefore, a returning force (A) due to deformation of the resilient sleeve (20) is not parallel with the fastener (10) and aids securing the sleeve (20) in position. Further, during tightening, the external thread of the fixing end (22) of the sleeve is driven securely into the hole of the wall.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A molly bolt comprising:
a fastener having
a head;
a shaft protruding from the head of the fastener and having
a smooth segment being connected to the head of the fastener;
a threaded segment being formed adjacent to the smooth segment; and
an engaging segment being connected to the thread segment; and
a connecting end being formed adjacent from the engaging segment of the shaft;
a sleeve being mounted around the shaft of the fastener and having
a through hole being formed through the sleeve; a fixing end being disposed adjacent to the head of the fastener;
a rim being formed on the sleeve at the fixing end of the sleeve;
a compressing segment being connected to the fixing end and mounted around the shaft and having
an asymmetric structure being formed asymmetrically in the compressing segment to allow the compressing segment to be compressed by an asymmetric pulling force toward the fixing segment along the thread segment of the fastener and deformed as an asymmetric deformation adjacent to the smooth segment; and
an engaging end being formed on and protruding from the compressing segment, and engaging the engaging segment of the fastener; and
a tip being mounted on the connecting end of the fastener.

2. The molly bolt as claimed in claim 1, wherein the asymmetric structure is a single straight slot.

3. The molly bolt as claimed in claim 1, wherein the asymmetric structure is a single slant slot.

4. The molly bolt as claimed in claim 1, wherein the asymmetric structure is multiple straight slots and multiple cambers, wherein
the straight slots are formed asymmetrically in the compressing segment; and
the cambers between adjacent slots are formed on the compressing segment and have lengths, wherein the length of at least one of the cambers is different from that of the other cambers.

5. The molly bolt as claimed in claim 1, wherein the asymmetric structure is multiple slanted slots and multiple cambers, wherein
the straight slots are formed asymmetrically in the compressing segment; and
the cambers each between adjacent slots are formed on the compressing segment have lengths, wherein the length of at least one of the cambers is different from that of the other cambers.

6. The molly bolt as claimed in claim 2, wherein the straight slot is formed intermittently in the compressing segment and has multiple aligning crevices.

7. The molly bolt as claimed in claim 3, wherein the slant slot is formed intermittently in the compressing segment and has multiple aligning crevices.

8. The molly bolt as claimed in claim 4, wherein at least one of the multiple asymmetrical slots is formed intermittently in the compressing segment and has multiple aligning crevices.

9. The molly bolt as claimed in claim 5, wherein at least one of the multiple asymmetrical slots is formed intermittently in the compressing segment and has multiple aligning crevices.

10. The molly bolt as claimed in claim 1, wherein the asymmetric structure is multiple curved slots respectively being formed around the compressing segment, and being formed side by side along the longitudinally axially in the sleeve.

11. The molly bolt as claimed in claim 10, wherein the multiple curved slots are arcs less than 180°.
